(19) United States
(12) Patent Application Publication
(10) Pub. No.: US 2017/0216766 A1
(43) Pub. Date: Aug. 3, 2017

(54) MODULAR SYSTEMS AND METHODS FOR DEVELOPING GAS FIELDS

(71) Applicant: Fluor Technologies Corporation, Sugar Land, TX (US)

(72) Inventors: Stephen George Mogose, Farnborough (GB); Paul Andrews, Farnborough (GB)

(21) Appl. No.: 15/011,748

(22) Filed: Feb. 1, 2016

(51) Int. Cl. B01D 53/26; E21B 43/34

(52) U.S. Cl. CPC B01D 53/266; E21B 43/34

(57) ABSTRACT

A natural gas production module including a wellhead configured to supply a stream of raw natural gas from a subterranean formation, and a first truckable gas processing module in fluid communication with the wellhead, wherein the first gas processing module includes a component configured to process the raw gas supplied by the wellhead.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Embodiments disclosed herein relate generally to systems and methods for developing and producing gas fields. More particularly, embodiments disclosed herein relate to modular or “plug and play” systems and associated methods for unconventional gas development operations.

Natural gas production operations may rely on infrastructure at the production pad or module (i.e., at or proximal the wellhead) and/or downstream of the wellhead for processing the produced gas. In some applications, processing at the production pad often includes gas-oil separation, the removal of condensate, dehydration, contaminant removal, and nitrogen extraction, while downstream processing distal the wellhead usually includes demethanization and fractionation. In conventional gas development operations, the equipment utilized for performing gas-oil separation and other processing operations at the production pad are constructed onsite as part of a custom or bespoke processing system custom designed for that particular processing pad or wellhead.

The production of unconventional gas developments, such as shale gas fields, provide additional challenges as each well in the field may be smaller in capacity as compared to conventional gas developments, and thus, each production pad often has a short life expectancy. In addition, the wells in an unconventional gas development tend to be more widely distributed across the field as compared to conventional gas developments.

### BRIEF SUMMARY OF THE DISCLOSURE

An embodiment of a natural gas production module comprises a wellhead configured to supply a stream of raw natural gas from a subterranean formation, anal a first trackable gas processing module in fluid communication with the wellhead, wherein the first gas processing module comprises a component configured to process the raw gas supplied by the wellhead. In some embodiments, the component of the first gas processing module comprises a separator vessel configured for separating a condensate from the raw gas. In some embodiments, the component of the first gas processing module comprises a turbine configured for producing electrical energy from combusting the raw gas provided by the wellhead. In certain embodiments, the first gas processing module comprises an integrated power and control system configured for receiving electrical energy to power the component of the first gas processing module. In certain embodiments, the first gas processing module is sized and configured to be transported on a semi- trailer truck on commercial roadways. In certain embodiments, the gas production pad further comprises a second gas processing module disposed at the gas production module and directly fluidically and electrically coupled to the first gas processing module. In some embodiments, the second gas processing module is stacked on top of the first gas processing module at the gas production module.

An embodiment of a system for developing a natural gas field comprises a storage facility, and a plurality of trackable gas processing modules stored in the storage facility wherein each trackable gas processing module is configured to be coupled to a wellhead of a gas production module, and wherein each truckable gas processing module comprises a component configured for processing a stream of raw gas provided by the wellhead. In some embodiments, the component of one of the gas processing modules comprises one or more of a separator vessel configured for separating a condensate from the raw gas and a condensate storage vessel configured for storing the condensate collected from the raw gas provided by the wellhead. In some embodiments, one of the gas processing in has a size equal to or less than an intermodal standardized shipping container. In certain embodiments, one of the gas processing modules is configured to be installed at multiple gas production modules. In certain embodiments, one of the gas processing modules comprises an integrated power and control system configured for receiving electrical energy to power the component of the gas processing module. In some embodiments, the component of one of the gas processing modules comprises a turbine configured for producing electrical energy from combusting the raw gas provided by the wellhead. In some embodiments, one of the gas processing modules is sized and configured to be transported on a semi-trailer truck on commercial roadways.

An embodiment of a method of producing and processing natural gas comprises (a) fabricating a plurality of truckable gas processing modules, wherein each gas processing module comprises a component for processing natural gas, (b) selecting one or more of the gas processing modules after (a) for installation at a first gas production module comprising a wellhead, (c) transporting each of the one or more selected gas processing modules by truck to the first gas production module, (d) installing the one or more selected gas processing modules at the first gas production module, and (e) processing natural gas produced from the wellhead with the one or more selected gas processing modules after (d). In some embodiments, (a) further comprises storing the plurality of gas processing modules at a centralized storage facility. In some embodiments, (b) further comprises determining the number and type of gas processing modules to be installed at the first gas production module. In certain embodiments, the method further comprises (f) installing another of the plurality of gas processing modules at the first gas production module in response to a change in the flowrate of natural gas produced by the wellhead. In some embodiments, the method further comprises removing at least one gas processing module from the first gas production module and installing the at least one gas processing module at a second gas production module distal the first gas production module after (e). In certain embodiments, (e) comprises separating a condensate from a raw gas feed supplied by the wellhead.

### BRIEF DESCRIPTION OF THE DRAWINGS

For a detailed description of various exemplary embodiments, reference will now be made to the accompanying drawings in which:

FIG. 1 is a schematic illustration of an embodiment of a modular gas development system in accordance with the principles disclosed herein;

FIG. 2 is a schematic illustration of one of the modular gas production modules of FIG. 1;

FIG. 3 is a schematic illustration of another one of the modular gas production modules of FIG. 1;

FIG. 4 is a schematic illustration of another one of the modular gas production modules of FIG. 1;

FIG. 5 is a schematic perspective view of a plurality of trackable modules of a modular gas production module in accordance with the principles disclosed herein; and

FIG. 6 is a graphical illustration of an embodiment of a method for developing gas in accordance with the principles disclosed herein.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment,

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. As used herein, the term “well site personnel” is used broadly to include any individual or group of individuals who may be disposed or stationed on a rig or worksite or offsite at a remote monitoring location (such as a remote office location). The term also would include any personnel involved in the drilling and/or production operations at or for an oil and gas well such as, for example, technicians, operators, engineers, analysts, etc.

As previously described, unconventional gas developments typically include widely distributed wells having shorter production lives as compared to conventional gas developments. Consequently, it may not be economically viable to utilize the same production systems and methods used in conventional gas developments. Accordingly, embodiments of systems and methods described herein provide generic, reusable, and modular “plug and play” gas production and processing modules for economically viable use in unconventional gas development operations. Further, the generic modules are configured to be trackable such that they may be conveniently transported, installed, and removed from the production pad or module. As will be explained further herein, the utilization of generic modules reduces the costs associated with transporting, installing, and removing the equipment required at the production module for processing the gas produced therefrom, thereby increasing the economic viability of the gas development operation. Although the systems and methods described herein may have particular advantages within the context of unconventional gas developments, they can also be used in connection with conventional gas developments.

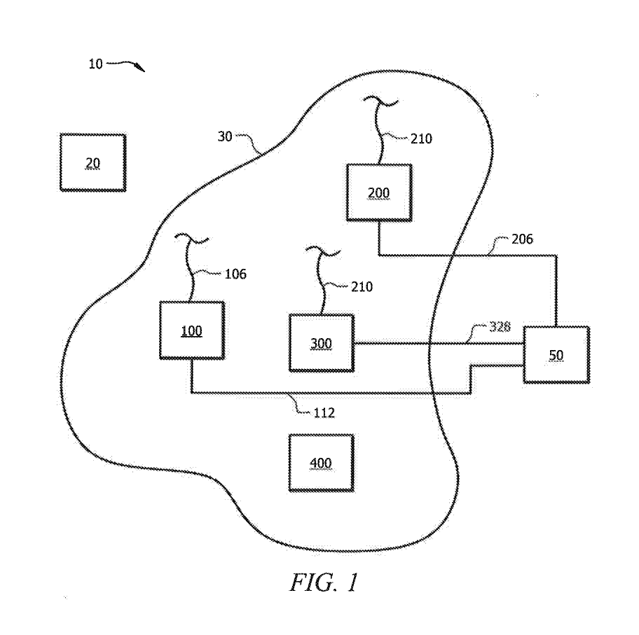

Referring now to FIG. 1, an embodiment of a gas development system 10 for producing natural gas in a gas field 30 is shown. In this embodiment, gas field 30 is an unconventional shale gas field, however, in general, system 10 can be used to produce any type of gas field. Gas development system or operation 10 generally includes a module fabrication and storage facility 20, remote gas field 30, a downstream processing facility or plant 50, and a plurality of gas production pads or modules 100, 200, 300, 400 distributed throughout gas field 30.

Each gas production module 100, 200, 300, 400 is configured to receive raw, unprocessed natural gas from a subterranean formation extending beneath the gas field 30, and perform preliminary processing of the natural gas prior to conversion of the gas into electrical energy and/or transport of the natural gas to the downstream processing facility 50 for further processing. A wellhead is provided at each gas production module 100, 200, 300, and 400 for supplying the raw, unprocessed natural gas from the subterranean formation. As will be explained further herein, each gas production module 100, 200, 300, 400 includes varying components for performing different processing operations on the raw gas. Although the embodiment shown in FIG. 1 illustrates four gas production modules 100, 200, 300, 400, in other embodiments, in general, any number of gas production modules can be provided. Moreover, although each gas production module 100, 200, 300, 400 includes a single wellhead for producing the raw, unprocessed gas from the subterranean formation to the surface, in other embodiments, more than one wellhead can supply raw, unprocessed natural gas to any one or more production modules,

Referring still to FIG. 1, fabrication and storage facility 20 serves as the site for the fabrication and storage of the pre-designed and generic gas processing modules used to construct each gas production module 100, 200, 300, 400. More specifically, each gas production module 100, 200, 300, 400 includes one or more pre-designed gas processing modules that are constructed and stored at facility 20, and then transported from storage facility 20 to the location of corresponding production module 100, 200, 300, 400, where they are assembled to form the module 100, 200, 300, 400. Thus, the gas processing functionality provided at each gas production module 100, 200, 300, 400 is defined by the type, number, and combination of gas processing modules that form the respective gas production module 100, 200, 300, 400. In this arrangement, the pre-designed modules are generic, and thus, are not tailored in design or construction for use with any particular gas production module 100, 200, 300, 400 of system 10. Instead, upon determining the processing functionality desired for a particular gas production module 100, 200, 300, 400, one or more of the gas processing modules stored at storage facility 20 are selected to provide the predetermined functionality. In other words, rather than fabricating the gas processing equipment on-site at each gas production module 100, 200, 300, 400, per conventional practice, in this embodiment, generic gas processing modules are selected at storage facility 20 and subsequently transported to the respective gas production module 100, 200, 300, 400 for installation.

Given that the gas processing modules that form gas production modules 100, 200, 300, 400 are generic, at least some of the gas production modules can be reused at other modules 100, 200, 300, 400 and/or in other gas development systems or operations. Although system 10 includes a single, centralized fabrication and storage facility 20, in other embodiments, the generic gas processing modules used to construct gas production modules 100, 200, 300, 400 can be transported from more than one decentralized location depending upon the application.

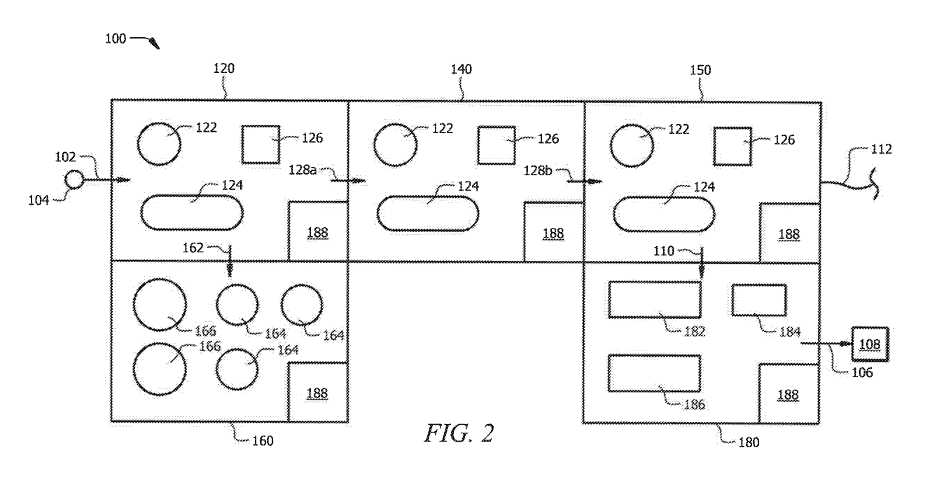

Referring now to FIG. 2, one gas production module 100 of system 10 is shown in FIG. 2. In this embodiment, gas production module 100 includes five pre-designed and pre-fabricated gas processing modules—a high-pressure separator module 120, a medium-pressure separator module 140, a low-pressure separator module 150, a water treatment module 160, and a power generation module 180. Accordingly, gas production module 100 receives a stream or feed of raw, unprocessed gas 102 from a corresponding wellhead 104 at module 100 adjacent modules 120, 140, 150, 160, 180, processes the gas 102 from wellhead 104, and produces electricity 106 with the processed gas. The electricity 106 is supplied to an electrical grid 108 for subsequent transmission and distribution. Thus, in this embodiment, gas production module 100 both processes raw gas stream 102 and converts the raw gas 102 into electricity.

In embodiments described herein, each gas processing module (e.g., each module 120, 140, 150, 160, 180) at each gas production module 100, 200, 300, 400 is “truckable,” meaning it has a size, shape, and weight suitable for transport with a semi-trailer truck on commercial roadways. Thus, the gas processing modules are similar in dimensions with intermodal or large standardized shipping containers to facilitate truck transport on commercial roadways.

To facilitate truckability, each gas processing module of gas development system 10 includes a support structure, frame or housing for securing and physically supporting the equipment and hardware contained within. The equipment and hardware provided in each gas processing module may include gas processing equipment, platforms, wiring, instrumentation, and lighting. Further, depending upon the type of equipment or components stored within and the functionality provided by the gas processing module, the gas processing modules of gas development system 10 may be enclosed on each side, as well as the top and bottom, or the gas processing modules may have one or more open sides. In some embodiments, the bottom of one or more of the gas processing modules is incorporated into or defined by the bed of the truck on which it is transported from storage facility 20 and its corresponding gas production module to simplify installation and removal of the gas production module from its associated gas production module.

Referring specifically to the gas processing modules of module 100, separator modules (i.e., separator modules 120, 140, 150) separate liquid condensate and water from raw gas 102 before it is supplied to power generation module 180 for combustion and generation of electricity 106. Separator modules 120, 140, 150 are connected in series and act in conjunction to provide a stepwise reduction in the liquid condensate in the produced gas 102 to enhance the recovery of liquid condensate therefrom. In particular, the raw gas 102 passes through high-pressure separator module 120 and is output from module 120 to medium-pressure separator module 140 via a first interconnect 128a, and then passes through medium-pressure separator module 140 and is output from module 140 to low-pressure separator module 150 via a second interconnect 128b, and then passes through module 150.

In this embodiment, each separator module 120, 140, 150 generally includes a plurality of components, to wit, potentially a cooler 122, a separator vessel 124, and a compressor 126. The gas stream enters the corresponding separator vessel 124, which physically separates the liquid condensate and water entrained in the raw gas 102. The remaining gas is flowed to the corresponding compressor 126 for compression, while the liquid condensate is flowed into the corresponding separator vessel 124. The separator vessel 124 separates water from the liquid condensate. The separated water is supplied from vessel 124 to the water treatment module 160 via an interconnect 162 for further processing and/or storage, while the liquid condensate is supplied from vessel 124 to processing facility 50 via a fluid conduit or pipeline 112 for further processing. Once the raw gas 102 from wellhead 104 has passed through each separator module 120, 140, 150, the resulting processed gas is supplied to power generation module 180 via interconnect 110.

Although gas production module 100 includes three separator modules 120, 140, 150 in this embodiment, in other embodiments, the gas production module (e.g., module 100) may include any suitable number of separator modules. Moreover, in other embodiments, the gas production module may include a plurality of parallel processing or separation “trains” including two or more high-pressure separator modules 120, medium-pressure separator modules 140, and low-pressure separator modules 150, with each group of high, medium, and low-pressure separator modules operating in parallel. The inclusion of a plurality of parallel processing trains may be utilized to enhance processing capacity in applications exhibiting relatively high flow rates of raw gas 102. Moreover, given the inherent portability and truckability of the gas processing modules forming gas production module 100, individual gas processing trains may be added or removed from gas production module 100 over the lifespan of wellhead 104 and gas field 30 to accommodate for changes in the composition or flow rate of gas therefrom over time.

Referring still to FIG. 2, water treatment module 160 receives water separated from raw gas 102 in each module 120, 140, 150, processes the water and stores the water. In this embodiment, water treatment module 160 includes a plurality of filters 164 and a plurality of storage vessels 166. The water supplied by separator modules 120, 140, 150 is filtered by filters 164, and thereafter supplied to vessels 166 for storage.

Power generation module 180 combusts the processed gas received from the train of separator modules 120, 140, 150 and converts the energy contained within the gas into electricity 106, which is supplied to electrical grid 108. In this embodiment, power generation module 180 includes a gas turbine 182, a steam generator 184, and a steam turbine 186. Thus, processed gas from modules 120, 140, 150 is supplied to gas turbine 182 where it is combusted to generate heat used to heat, water disposed within steam generator 184, which in turn generates steam. The steam from steam generator 184 is then supplied to steam turbine 186, which produces electricity 106 via a generator. In this embodiment, steam generator 184 is provided with water for steam generation from eater treatment module 160 via an interconnect therebetween (not shown). In addition, in this embodiment, electricity from power generation module 180 is provided to a power and control system 188 of each gas processing module 120, 140, 150, 160, 180 of gas production module 100. Power and control systems 188 are linked or networked via fiber optic connections (not shown) extending therebetween. In this manner, gas production module 100 is self-powered, meaning it does not rely on electricity from an electrical grid for powering and controlling the equipment of modules 120, 140, 150, 160, 180.

As shown in FIG. 2, the gas processing modules 120, 140, 150, 160, 180 are configured and arranged so as to minimize the number of interconnects (e.g., interconnects 128a, 128b, 162, etc.) extending between modules to thereby decrease the amount of time required to install modules 120, 140, 150, 160, 180 at gas production module 100. The layouts of the gas processing modules of gas production module 100 and positioning of interconnects therebetween may be determined utilizing a 3rd Generation Modular approach, as described in U.S. Pat. No. 8,931,217, which is hereby incorporated herein by reference in its entirety.

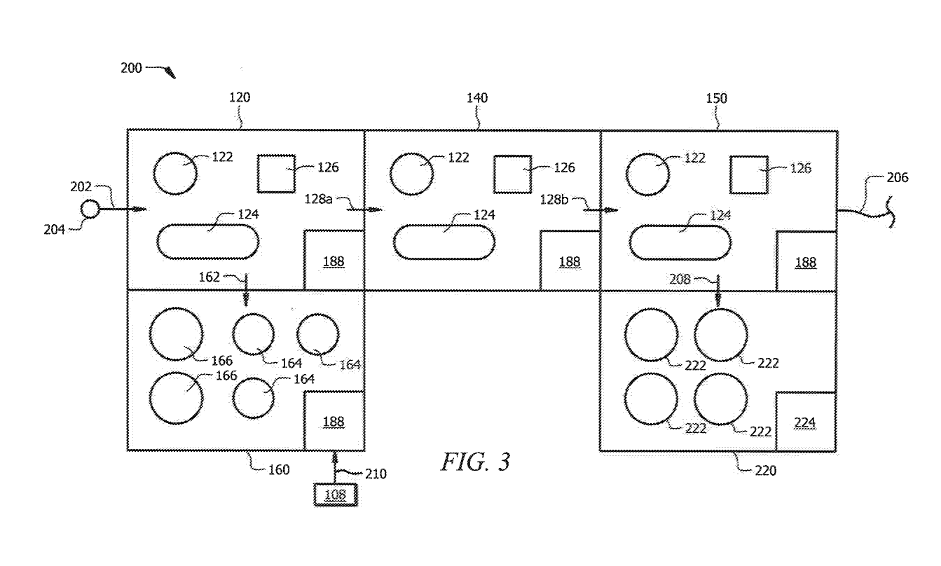

Referring to FIG. 3, gas production module 200 of gas development operation 10 is shown. Gas production module 200 shares features with gas production module 100 discussed above, and shared features are similarly labeled in the figures. In this embodiment, gas production module 200 includes a plurality of components, to wit, a high-pressure separator module 120, a medium-pressure separator module 140, a low-pressure separator module 150, and a water treatment module 160. Separator modules 120, 140, 150, and water treatment module 160 are arranged and function similarly to those previously described with respect to module 100, and thus, receive a raw, unprocessed gas 202 from a wellhead 204 and outputs gas to processing facility 50 via a pipeline or fluid conduit 206 extending therebetween. However, unlike module 100 described above, in this embodiment, module 200 also includes a truckable condensate storage module 220, and does not include a power generation module 180.

Condensate storage module 220 receives and stores liquid condensate from separator modules 120, 140, 150 via a fluid interconnect 208 extending therebetween. In this embodiment, condensate storage module 220 includes a plurality of condensate storage vessels 222 and power and control system 224, similarly configured as the power and control system 188 of the other gas processing modules of gas production module 100. In this configuration, condensate storage vessels 222 are configured to receive and store liquid condensate from separator modules 120, 140, 150. Over the course of the lifespan of gas production module 200, condensate storage module 220 is periodically replaced as condensate storage vessels 222 are filled to capacity with liquid condensate. Thus, instead of utilizing a pipeline for transporting produced liquid condensate, condensate storage module 220 may be utilized to store and subsequently truck collected liquid condensate to processing facility 50 or other destinations.

Since gas production module 200 does not include a power generation module 180, it receives electricity from, and is powered by, an electrical energy input 210 that transmits electrical power from electrical grid 108. Similar to the configuration of gas production module 100, electricity may be shared or networked between the gas processing modules of gas production module 200 via power and control systems 188 and 224, which are interconnected via fiber optic connections (not shown).

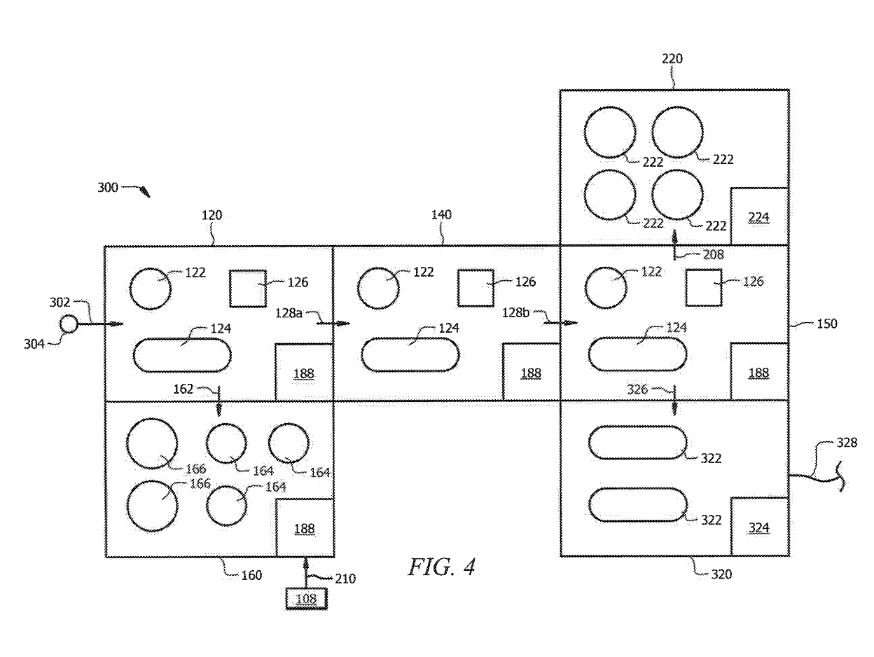

Referring now to FIG. 4, gas production module 300 of gas development operation 10 is shown. Gas production module 300 shares features with gas production modules 1.00 and 200 discussed above, and shared features are similarly labeled in the figures. As discussed above, the various gas production modules of gas development operation 10 can provide different gas processing functionality. For instance, gas production module 300 includes the capability of removing mercury from the raw, unprocessed gas prior to supplying the processed gas to processing facility 50. More specifically, in this embodiment, gas production module 300 includes a plurality of components, to wit, a high-pressure separator module 120, a medium-pressure separator module 140, a low-pressure separator module 150, and a water treatment module 160. Separator modules 120, 140, 150, and water treatment module 160 are arranged and function similarly to those previously described with respect to module 100, and thus, receive a raw, unprocessed gas 302 from a wellhead 304. However, unlike module 100 described above, in this embodiment, module 300 includes a trackable mercury removal module 320.

Mercury removal module 320 receives processed gas from low-pressure separator module 150 via a fluid interconnect 326, and removes mercury from the processed gas prior to supplying the processed gas to processing facility 50 via a pipeline or fluid conduit 328. It should be appreciated that different wells can produce raw natural gas containing varying amounts of mercury. In this embodiment, wellhead 304 produces raw gas 302 including substantial amounts of entrained mercury, which may damage downstream processing equipment, such as the equipment comprising processing facility 50. Thus, in this embodiment, it is advantageous to reduce the mercury content of raw gas feed 302 prior to transport to processing facility 50.

Mercury removal module 320 includes a plurality of mercury removal vessels 322 for removing mercury from the gas received via interconnect 326. In this embodiment, mercury removal vessels 322 comprise reaction vessels including metal sulphides disposed on a porous inorganic support, where the sulphides react with the mercury entrained in the gas feed, thereby binding the mercury to the sulphides and removing it from the gas flow. Although mercury removal vessels 322 include metal sulphide reactants in this embodiment, in other embodiments, the mercury removal vessels (e.g., mercury removal vessels 322) include other materials or mechanisms known in the art for removing mercury from natural gas. Over the lifespan of wellhead 304, mercury removal module 320 can be periodically replaced via truck as the reactants of mercury removal vessels 322 become inundated with mercury bonded thereto.

In this embodiment, mercury removal module 320 also includes a power and control system 324, similarly configured as the power and control system 188 of the other gas processing modules of gas production module 300. Similar to the configuration of gas production module 200, electrical energy input 210 may be shared or networked between the gas processing modules of gas production module 300 via power and control systems 188 and 324, which are interconnected via fiber optic connections (not shown). Further, although in this embodiment gas production module 300 includes mercury removal module 320, in other embodiments, gas production module 300 may comprise additional modules including varying types of processing functionality. For instance, in certain embodiments, gas production module 300 may include trackable modules providing dehydration, nitrogen rejection, acid gas removal, and other processes for conditioning raw gas feed 302.

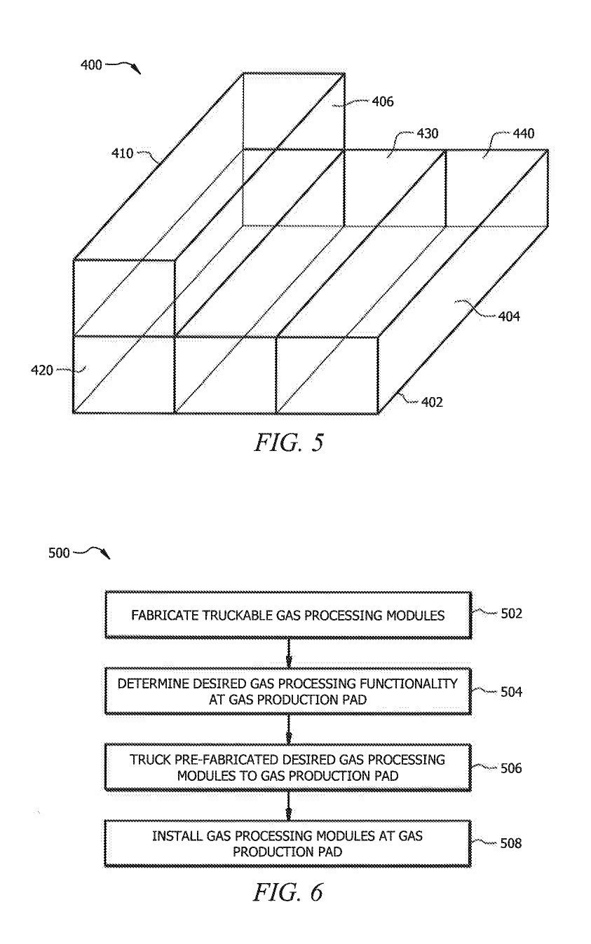

Although the schematic illustrations of modules 100, 200, 300 shown in FIGS. 2, 3, 4, respectively, suggest the individual gas processing modules are disposed at a single, common vertical level (e.g., all the gas processing modules are disposed on the ground), in other embodiments, the gas processing modules can be located on multiple vertical levels extending from the ground or surface of the respective gas production module. For instance, referring briefly to FIG. 5, a schematic, perspective view is shown of gas production module 400. In this embodiment, gas production module 400 generally includes gas processing modules 410, 420, 430, 440, where modules 410, 420, 430, 440 comprise any of the types of trackable gas processing modules discussed above with respect to gas production modules 100, 200, 300. In this embodiment, modules 420, 430, 440 are each disposed on the surface 402 at a first or surface level 404, while module 410 is disposed directly above and stacked atop module 420 at an elevated level 406. Moreover, while in this embodiment, gas production module 400 includes surface level 404 and elevated level 406, in other embodiments, gas production module 400 (as well as the other gas production modules discussed herein) may include multiple elevated or stacked levels disposed above elevated level 406.

Referring to FIG. 6, an embodiment of a method 500 for constructing a gas production module (e.g., module 100, 200, 300, 400), and producing and processing natural gas with the modules is shown. Starting at block 502, one or more truckable gas processing modules are fabricated or constructed. FIGS. 2-5 illustrate various types of truckable gas processing modules that may be utilized for processing gas at a gas production module; however, in other embodiments, other truckable gas processing modules may be utilized than the ones shown in FIGS. 2-5. In some embodiments, the pre-fabricated truckable gas processing modules may be stored after fabrication at a centralized storage facility, such as storage facility 20 shown in FIG. 1.

At block 504 of method 500, the desired gas processing functionality for a particular gas production module of a gas development operation is determined. In certain embodiments, block 504 comprises determining the types and amounts of the gas processing modules fabricated at block 502 required at a particular gas production module disposed in a gas field of the gas development operation. For instance, particular gas processing functionality may be desired depending upon the flow rate and amount of entrained materials projected to flow from the wellhead of the gas production module. Thus, in some applications, block 504 comprises determining that one or more mercury removal modules 320 (shown in FIG. 4) are required for removing mercury entrained in the projected raw gas feed. In other embodiments, block 504 comprises determining that power generation module 180 (shown in FIG. 2) is required for powering the gas production module in applications where electrical connections to a local electrical grid are impractical. In still further embodiments, block 504 comprises determining whether one or more parallel trains of gas processing modules (e.g., separator modules 120, 140, 150, etc.) are required in applications including relatively high flow rates of raw gas feed.

At block 506 of method 500, the desired or selected pre-fabricated gas processing modules are trucked to the gas production module for installation. In certain embodiments, block 506 comprises towing or trucking the gas processing modules to the gas production module using a semi-trailer truck via commercial roadways. In some embodiments, gas processing modules may be trucked from a centralized storage facility, such as storage facility 20, to the gas production module for installation, while in other embodiments, the gas processing modules may be trucked from varying locations to the gas production module. In some embodiments, block 506 comprises detaching the gas processing modules from the wheels of the semi-trailer truck in applications where the modules themselves form or comprise the bed of the truck. At block 508 of method 500, the selected gas processing modules are installed at the gas production module. In sonic embodiments, block 508 comprises determining a layout of the transported gas processing modules to minimize interconnects between the modules. In certain embodiments, block 508 comprises arranging the gas processing modules onto different levels, such that some of the gas processing modules are stacked on top of one another.

Following block 508, some embodiments of method 500 may further include operating the gas production module to produce and process gas from a subterranean formation disposed beneath the gas production module. In some embodiments, this includes periodically replacing particular gas processing modules, such as condensate storage module 220 shown in FIG. 3 or mercury removal module 320 shown in FIG. 4. Moreover, in some embodiments, method 500 comprises adding or removing additional gas processing modules or parallel processing trains to accommodate changes in flow rate or composition of the raw gas emitted from the wellhead of the gas production module. In some embodiments, method 500 may further comprise uninstalling the gas processing modules at the end of the service life of the gas production module, and trucking the gas processing modules either to a centralized storage facility, or to other locations, where the gas processing modules may be reused in the future at other gas production modules in other gas development operations.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A natural gas production module, comprising:
a wellhead configured to supply a stream of raw natural gas from a subterranean formation; and
a first truckable gas processing module in fluid communication with the wellhead, wherein the first gas processing module comprises a component configured to process the raw gas supplied by the wellhead.

2. The gas production module of claim 1, wherein the component of the first gas processing module comprises a separator vessel configured for separating a condensate from the raw gas.

3. The gas production module of claim 1, wherein the component of the first gas processing module comprises a turbine configured for producing electrical energy from combusting the raw gas provided by the wellhead.

4. The gas production module of claim 1, wherein the first gas processing module comprises an integrated power and control system configured for receiving electrical energy to power the component of the first gas processing module.

5. The gas production module of claim 1, wherein the first gas processing module is sized and configured to be transported on a semi-trailer truck on commercial roadways.

6. The gas production module of clam 1, further comprising a second gas processing module disposed at the gas production module and directly fluidically and electrically coupled to the first gas processing module.

7. The gas production module of claim 6, wherein the second gas processing module is stacked on top of the first gas processing module at the gas production module.

8. A system for developing a natural gas field, the system comprising:
a storage facility; and
a plurality of truckable gas processing modules stored in the storage facility wherein each truckable gas processing module is configured to be coupled to a wellhead of a gas production module, and wherein each truckable gas processing module comprises a component configured for processing a stream of raw gas provided by the wellhead.

9. The gas development system of claim 8, wherein the component of one of the gas processing modules comprises one or more of:
a separator vessel configured for separating a condensate from the raw gas and a condensate storage vessel configured for storing the condensate collected from the raw gas provided by the wellhead.

10. The gas development system of claim 8, wherein one of the gas processing modules has a size equal to or less than an intermodal standardized shipping container.

11. The gas development system of claim 8, wherein one of the gas processing modules is configured to be installed at multiple gas production modules.

12. The gas development system of claim 8, wherein one of the gas processing modules comprises an integrated power and control system configured for receiving electrical energy to power the component of the gas processing module.

13. The gas development system of claim 8, wherein the component of one of the gas processing modules comprises a turbine configured for producing electrical energy from combusting the raw gas provided by the wellhead.

14. The gas development system of claim 8, wherein one of the gas processing modules is sized and configured to be transported on a semi-trailer truck on commercial roadways.

15. A method of producing and processing natural gas, comprising:
(a) fabricating a plurality of trackable gas processing modules, wherein each gas processing module comprises a component for processing natural gas;
(b) selecting one or more of the gas processing modules after (a) for installation at a first gas production module comprising a wellhead;
(c) transporting each of the one or more selected gas processing modules by truck to the first gas production module;
(d) installing the one or more selected gas processing modules at the first gas production module; and
(e) processing natural gas produced from the wellhead with the one or no selected gas processing modules after (d).

16. The method of claim 15, wherein (a) further comprises storing the plurality of gas processing modules at a centralized storage facility.

17. The method of claim 15, wherein (b) further comprises determining the number and type of gas processing modules to be installed at the first gas production module.

18. The method of claim 15, further comprising (f) installing another of the plurality of gas processing modules at the first gas production module in response to a change in the flowrate of natural gas produced by the wellhead.

19. The method of claim 15, further comprising removing at least one gas processing module from the first gas production module and installing the at least one gas processing module at a second gas production module distal the first gas production module after (e).

20. The method of claim 15, wherein (e) comprises separating a condensate from a raw gas feed supplied by the wellhead.
